(19) United States
(12) Patent Application Publication
(10) Pub. No.: US 2018/0304305 A1
(43) Pub. Date: Oct. 25, 2018

(54) MULTILAYERED COATING FILM AND COATED ARTICLE

(71) Applicant: MAZDA MOTOR CORPORATION, Hiroshima (JP)

(72) Inventors: Takakazu YAMANE, Hiroshima-shi (JP); Kouji TERAMOTO, Hiroshima-shi (JP); Fumi HIRANO, Hiroshima-shi (JP); Keiichi OKAMOTO, Hiroshima-shi (JP)

(73) Assignee: Mazda Motor Corporation, Hiroshima (JP)

(21) Appl. No.: 15/763,305

(22) PCT Filed: Nov. 28, 2016
(86) PCT No.: PCT/JP2016/085222

§ 371 Date: Mar. 26, 2018

(30) Foreign Application Priority Data
Dec. 2, 2015 (JP) 2015-236119

(51) Int. Cl. B05D 1/36; B05D 5/06; B32B 27/20; B32B 7/02; C09D 17/00; C09D 7/40

(52) U.S. Cl. CPC B05D 1/36; B05D 5/06; C09D 7/69; B32B 7/02; C09D 17/005; B32B 27/20

(57) ABSTRACT

A metallic base coating film 15 is stacked on a colored base coating film 14 provided on a surface of an article to be coated. While the colored base coating film 14 alone is formed on the surface of the article to be coated, a light reflectance at light receiving angles of 15° and 45° is measured to be 2% or below in a wavelength ranging from 450 nm to 700 nm inclusive. On the metallic base coating film 15 alone, the light reflectance measured at the light receiving angle of 15° ranges from 20% to 50% inclusive in the wavelength ranging from 450 nm to 700 nm inclusive, and the light reflectance measured at the light receiving angle of 45° is 2.5% or below in the wavelength ranging from 450 nm to 700 nm inclusive.

### TECHNICAL FIELD

The present invention relates to a multilayered coating film and a coated article.

### BACKGROUND ART

Recently, as coating films for automotive bodies, multilayered coating films known in the art have high chroma, high lightness, and depth in color to provide the bodies with high-quality color tone. A multilayered coating film includes: a metallic base coating film containing a luster material; and color-clear coating film containing a color pigment and applied on the metallic base coating film. Such a multilayered coating film is referred to as “candy paint” coating film for chromatic color and “metallic texture” coating film for achromatic color.

The candy paint coating film and the metallic texture coating film are catching attention to make appearances of automotive bodies look attractive. Meanwhile, in order to provide an even color tone throughout a complex automotive body, these coating films require strict management of such a painting condition as reducing variation in film thickness in a paint job. Failure in the management of the painting condition tends to cause such a problem as color unevenness, failing to provide the uniform color tone. Moreover, because the candy paint coating film and the metallic texture coating film require the strict reduction in variation of film thickness in a paint job, the productivity in the paint job is inevitably low.

Japanese Unexamined Patent Publication No. 2001-314807 (Patent Document 1) discloses a method for forming a multilayered coating film including: applying first paint containing a luster material to form a first coating film; applying second paint containing a colored component without baking and curing the first paint to form a second coating film on the first coating film; and forming a clear coating film on the second coating film and baking and curing all of the coating films. A content of the colored component in the second paint ranges from 0.01% by weight to 1% by weight with respect to the resin solid content. This technique is to overcome a weakness in use of color clear through controlling the content of the colored component of the second paint in the second coating film, preventing unevenness and loss of color in the coating film. However, when a candy paint coating film or a metallic texture coating film are to be obtained, even this technique tends to cause color unevenness and has a difficulty in producing even paint color and color tone. In addition, the coating films require strict reduction in variation of film thickness in a paint job. Thus, the productivity in the paint job does not increase.

Japanese Unexamined Patent Publication No. 2007-167720 (Patent Document 2) discloses a method for forming a multilayered coating including: applying metallic base paint containing a luster pigment to form a metallic base coating film; applying, on the metallic base coating film, colored base paint containing a color pigment to form a colored base coating film; and forming a clear coating film as a top layer and curing the entire films. The metallic base coating film has a lightness value L* of 60 and below. When the colored base coating film has a wavelength ranging from 400 nm to 700 nm inclusive, its luminous transmittance ranges from 30% to 50% inclusive. This technique also describes how to reduce color unevenness due to variation in film thickness of a candy paint coating film. However, even this technique cannot sufficiently improve productivity, and candy paint coating films or metallic texture coating films are required to have more depth in color.

### CITATION LIST

### Patent Documents

PATENT DOCUMENT 1: Japanese Unexamined Patent Publication No. 2001-314807

PATENT DOCUMENT 2: Japanese Unexamined Patent Publication No. 2007-167720

### SUMMARY OF THE INVENTION

### Technical Problem

In view of the forgoing background, it is therefore an object of the present invention to obtain a multilayered coating film with high-quality color tone. The coating film is less likely to cause color unevenness without significant reduction in film thickness variation in a paint job, produces even color tone, remains unclouded and highly transparent, and have depth in color.

### SUMMARY OF THE INVENTION

A multilayered coating film according to the present invention includes: a colored base coating film formed on a surface of an article to be coated, and containing a color pigment but not a luster material; and a metallic base coating film formed on a surface of the colored base coating film, and containing a color pigment and a luster material, wherein while the colored base coating film alone but not the metallic base coating film is formed on the surface of the article to be coated, a light reflectance at a light receiving angle of 15° and a light receiving angle at a light receiving angle of 45° are both measured to be 2% or below in a wavelength ranging from 450 nm to 700 nm inclusive, the light receiving angle representing an angle from a specular reflection angle toward a light source when a light of the light source is incident on a surface of the colored base coating film at an angle of 45° from normal to the surface, and on the metallic base coating film alone, the light reflectance measured at the light receiving angle of 15° ranges from 20% to 50% inclusive when the wavelength ranges from 450 nm to 700 nm inclusive, and the light reflectance measured at the light receiving angle of 45° is 2.5% or below when the wavelength ranges from 450 nm to 700 nm inclusive.

The color pigment of the colored base coating film may be identical to the color pigment of the metallic base coating film. When the multilayered coating film is colored gray, the color pigment may be a carbon-black-based pigment.

The metallic base coating film may have a thickness ranging from 1 μm to 5 μm inclusive and a pigment mass concentration ranging from 10% to 20% inclusive.

The luster material of the metallic base coating film may include aluminum flakes made of ground aluminum foil, and have a thickness ranging from 25 nm to 200 nm inclusive.

The aluminum flakes may be oriented at an angle of 3° or less with respect to a surface of the metallic base coating film.

The multilayered coating film may further include a transparent clear coating film formed on the surface of the metallic base coating film.

Examples of a coated article formed of an article to be coated provided with the multilayered coating film may include an automotive body or a body of any other kind of vehicles such as a motorcycle. The examples may also include such a product as a metal product.

### Advantages of the Invention

In accordance with the present invention, the light reflectance observed when the colored base coating film alone is formed on the surface of the article to be coated and the light reflectance with the metallic base coating film alone are defined as described above. Such features contribute to obtaining a high-quality multilayered coating film causing no color unevenness, remaining unclouded and highly transparent, and having depth in color.

### BRIEF DESCRIPTION OF THE DRAWINGS

FIG. 1 is a diagram schematically illustrating a cross-sectional view of a multilayered coating film.

FIG. 2 is a diagram explaining how to measure a light reflectance.

FIG. 3 is a graph illustrating a light reflectance characteristic, at a light receiving angle of 15°, of a single colored base coating film and a metallic base coating film alone according to Examples.

FIG. 4 is a graph illustrating a light reflectance characteristic, at a light receiving angle of 45°, of a single colored base coating film and a metallic base coating film alone according to Examples.

FIG. 5 is a graph illustrating a result of measuring a lightness L* according to Example 1.

FIG. 6 is a graph illustrating a result of measuring a color unevenness degree ΔL* according to Example 1.

### DESCRIPTION OF EMBODIMENT

An embodiment of the present invention will now be described with reference to the drawings. The following description of preferred embodiment is only an example in nature, and is not intended to limit the scope, applications or use of the present invention.

<Example Configuration of Multilayered Coating Film>

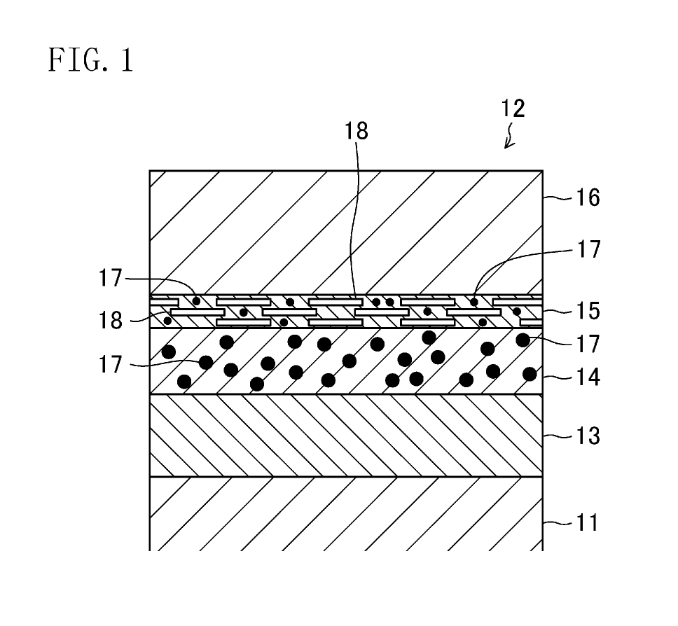

As illustrated in FIG. 1, a multilayered coating film 12 provided on a surface of an automotive body (steel plate) 11 according to the present embodiment contains a colored base coating film 14, a metallic base coating film 15, and a transparent clear coating film 16 which are sequentially stacked one upon the other. An electrodeposition coating film (undercoat) 13 is formed on the surface of the automotive body 11 by cationic electrodeposition. The multilayered coating film 12 is provided on the electrodeposition coating film 13.

The colored base coating film 14 contains a color pigment 17 but not a luster material. The metallic base coating film 15 contains the color pigment 17 and a luster material 18. Concealing a color of an underlayer (the electrodeposition coating film 13), the colored base coating film 14 can produce a color tone with high transparency in combination with the metallic base coating film 15 and the transparent clear coating film 16.

The multilayered coating film 12 according to the present invention can be obtained in the following steps carried out in the stated order: (i) applying, to a surface of an article to be coated (the electrodeposition coating film 13 provided to the automotive body 11 in the example of FIG. 1), colored base paint containing a color pigment but not a luster material, and obtaining the colored base coating film 14; (ii) applying, to the colored base coating film 14, metallic base paint containing a color pigment and a luster material, and forming the metallic base coating film 15; (iii) applying clear paint to the metallic base coating film 15, and forming the transparent clear coating film 16; and (vi) heating and curing the colored base coating film 14, the metallic base coating film 15, and the transparent clear coating film 16 respectively obtained in the steps (i), (ii), and (iii), and forming the multilayered coating film 12.

<Article to be Coated>

Examples of the above article to be coated include: metals such as iron, steel, aluminum, tin, and zinc, an alloy including such metals; and a molded product plated or vapor-deposited with these metals, and a molded product made of glass, plastic, and foam. Specifically, the examples of the articles to be coated include the automotive body 11 illustrated in FIG. 1 and an automotive part. As illustrated in FIG. 1, the surface of the article to be coated may be provided with an undercoat film.

The undercoat film is formed to conceal a surface of a material, and prevent the surface from corroding and rusting. Such characteristics are obtained when undercoat paint is applied on the surface and then the coating film of the paint is heated to cure. The undercoat film has a thickness ranging from, for example, 10 μm to 50 μm inclusive when dried. Specific examples of the undercoat paint include, but not limited to, cationic electrodeposition paint and anion electrodeposition paint. More specifically, the examples include such paint well-known by those skilled in the art as paint containing: hydroxyl-containing resin, and blocked polyisocyanate; and resin including a sulfonium group, and a propargyl group. These paints are electrodeposition-coated, and heated to cure in accordance with a kind of the paint in use.

On the undercoat film of the article to be coated, a surfacer film may be formed. This surfacer film can be formed of surfacer applied to the undercoat film to, for example, conceal the surface of the article to be coated and the undercoat film, provide a top coat film with adhesivity, and prevent the top coat from chipping. The surfacer film has a thickness ranging from, for example, 10 μm to 50 μm inclusive when dried. The surfacer contains a coating-film forming component. Examples of the surfacer include such paint well-known by those skilled in the art as paint containing hydroxyl-containing polyester resin and/or hydroxyl-containing acrylic resin, melamine resin and/or blocked polyisocyanate. After applied in accordance with a kind of the paint in use, these paints are left at a room temperature or heated to dry or cure. Note that the above step (1) can be carried out with so-called “wet-on-wet painting” instead of curing the surfacer film.

<Colored Base Coating Film, Step (1)>

The colored base paint to form the colored base coating film is preferably curable paint, and contains a coating-film forming component and a color pigment.

Examples of the coating-film forming component include such resins as acrylic resin, polyester resin, epoxy resin, and urethane resin. Furthermore, the examples of the film-forming component can contain the above resins having a curable functional group, and a curing agent such as amino resin reactive with the curable functional group, and isocyanate resin blocked as needed.

The color pigment conceals a color of the surface of the article to be coated, and colors the multilayered coating film without cloud. Examples of the color pigment include such inorganic color pigments as carbon black, iron black, chrome black, copper chromate, titanium-based black pigment, and oxidized iron, and such organic color pigments as pigment black, and aniline black.

In view of coloring without cloud, an example of a content of the color pigment for the colored base paint is preferably, but not limited to, a pigment mass concentration (a mass of pigment contained in paint/a sum of the mass of the pigment contained in the paint and a solid mass of a coating-film forming component) ranging from 3% by mass to 20% inclusive by mass. If the pigment mass concentration is smaller than 3% by mass, the light reflectance is not sufficiently reduced. As a result, color unevenness might not be prevented. If the pigment mass concentration is greater than 20% by mass, a viscosity of the paint increases such that the paint becomes insufficiently paintable, and the smoothness of the paint surface cannot be obtained. As a result, the quality of the coating film might deteriorate. More preferably, the pigment mass concentration may range from 5% by mass to 15% by mass inclusive, and still more preferably, from 8% by mass to 12% by mass inclusive.

As needed, the colored base paint may contain such components well known by those skilled in the art as an extender pigment, a curable catalyst, a surface modifier, an ultraviolet absorber, and an antioxidant.

The colored base paint may be provided in a form of any given type, such as a solvent type, a water-dispersible type, or a water-soluble type.

While the colored base coating film alone but not the metallic base coating film is formed (hereinafter “single colored base coating film”) on the surface of the article to be coated (the article may be, for example, a steel plate coated with a cation electrodeposition coating film, and moreover, with a surfacer film), a light reflectance at a light receiving angle of 15° and a light reflectance at a light receiving angle of 45° are both measured to be 2% or below in a wavelength ranging from 450 nm to 700 nm inclusive.

If a characteristic of the light reflectance is out of this range, it is disadvantageous for forming a multilayered coating film having high transparency with no cloud and for reducing color unevenness. More preferably, the light reflectance at a light receiving angle of 45° may be equal to 1.0% or below in a wavelength of light ranging from 450 nm to 700 nm inclusive.

Such a characteristic of the light reflectance is necessary especially when the paint color is greyish. If the characteristic of the light reflectance is out of this range, it is disadvantageous for producing gray.

Using, for example, the type U-3310 spectrophotometer (manufactured by Hitachi), the light reflectance can be obtained through measurement of light emitted from a light source and a rate of a light intensity observed when the light reflects on the single colored base coating film. The light measurement is performed with a wavelength scan mode with a wavelength ranging from 300 nm to 780 nm inclusive, a scanning speed of 300 nm/min, and a sampling interval of 0.5 nm.

The light reflectance of the single colored base coating film is adjusted through adjustment of types of color pigments contained in the colored base paint, mass concentrations of the color pigments, and furthermore, a thickness of the film in a paint job. Specifically, when a paint color is grayish, paint contains a color pigment of carbon black, and has a pigment mass concentration ranging from 5% by mass to 20% by mass inclusive, and the paint is applied to have a dry film thickness ranging from 7 μm to 20 μm inclusive. Consequently, the obtained multilayered coating film can reduce the risk of color unevenness, produce even color tone, keep the multilayered coating film unclouded and transparent, and provide the multilayered coating film with depth in color.

The colored base paint to be applied may be diluted with an organic solvent and/or water so that a solid content concentration and a viscosity of the colored base paint can be appropriately adjusted. The colored base paint in the step (1) may be applied by air spray painting, airless spray painting, and electrostatic spray painting. In view of a coating efficiency, the colored base paint may be applied by electrostatic spray painting.

In order to reduce bleeding and inverting between the colored base coating film obtained in the step (1) and a metallic base coating film obtained in the step (2) to be described later, a temporal interval may be preferably provided between the step (1) and the subsequent step (2). This interval makes it possible to sufficiently vaporize the organic solvent and/or water contained in the colored base coating film. Hence, the appearance of the multilayered coating film to be obtained improves. The interval ranges from 15 seconds to 15 minutes inclusive, for example. Moreover, during the interval, the article to be coated provided with the colored base coating film may be heated. This heating may cure the colored base coating film. In view of saving energy, this heating is preferably so-called “pre-heating” instead of actively curing the colored base coating film. The pre-heating is to efficiently vaporize the organic solvent and/or water contained in the colored base coating film in a short period of time. A condition of the pre-heating ranges from 2 minutes to 10 minutes inclusive at a temperature ranging from 40° C. to 80° C. inclusive, for example. The above pre-heating can be carried out with, for example, a fan heater and an infrared heater.

<Metallic Base Coating Film, Step (2)>

The metallic base coating film formed in the step (2) can fine-adjust the color obtained with the colored base coating film, and increase cloudless transparency and depth in the color.

The metallic base paint to form the metallic base coating film is preferably curable paint, and contains the coating-film forming component, a color pigment, and a luster material.

The color pigment conceals the color of the surface of the article to be coated and provides the multilayered coating film with cloudless transparency. Examples of the color pigment include such inorganic color pigments as carbon black, iron black, chrome black, copper chromate, titanium-based black pigment, and oxidized iron, and such organic color pigments as pigment black, and aniline black.

The luster material is to provide lightness to the multilayered coating film to be obtained. The luster material is not limited to a particular type as long as the material satisfies a predetermined light reflectance. Examples of the luster material include the flaked aluminum powder, alumina powder, bronze powder, copper powder, tin powder, zinc powder, iron phosphide, metal-coated mica powder, and titanium-dioxide-coated mica powder. Preferably, the luster material may be flaked aluminum powder; that is, aluminum flakes, in view of efficiently obtaining the predetermined light reflectance.

Preferably, such an aluminum flake has a particle size of 8 μm or more and 20 μm or less. If the particle size is smaller than 8 μm, the aluminum flakes are less likely to be oriented properly. If the particle size is larger than 20 μm, some of the aluminum flakes may stick out of the metallic base coating film, and the corrosion resistance of the coating target may be reduced.

Preferably, the aluminum flake has a thickness of 25 nm or more and 200 nm or less. If the aluminum flake is excessively thin, more light passes through the flake, which affects adversely in obtaining luster. In addition, if the aluminum flake is excessively thin with respect to its particle size, the aluminum flakes are easily deformed, which adversely affects the orientation of the aluminum flakes. In view of this point, the thickness of the aluminum flake is preferably 0.4% or more of its particle size, that is, 30 nm or more, for example. On the other hand, if the aluminum flake is excessively thick, the aluminum flakes are less likely to be oriented properly. In addition, such an aluminum flake increases the necessary volume ratio of the aluminum flakes in the luster material-containing layer to ensure the luster. The physical properties of the coating film are therefore deteriorated. In view of this point, the thickness of the aluminum flake is preferably 200 nm or less. More preferably, the aluminum flake has a thickness of 80 nm or more and 150 nm or less.

Preferably, the aluminum flake has a surface roughness Ra of 100 nm or less to reduce diffuse reflection or scatter of the light.

An example of a content of the color pigment for the metallic base paint is preferably, but not limited to, a pigment mass concentration (a mass of pigment contained in paint/a sum of the mass of the pigment contained in the paint and a solid mass of a coating-film forming component) ranging from 5% by mass to 20% by mass inclusive, in view of obtaining lightness and unclouded transparency. If the pigment mass concentration is smaller than 5% by mass, the light reflectance is not sufficiently reduced. As a result, color unevenness might not be prevented. If the pigment mass concentration is greater than 20% by mass, the multilayered coating film cannot obtain sufficient cloudless transparency, lightness, and high-quality color tone. As a result, quality of the coating film could deteriorate. More preferably, the pigment mass concentration ranges from 10% by mass to 18% by mass inclusive.

An example of a content of the luster material for the metallic base paint is preferably, but not limited to, a pigment mass concentration ranging from 3% by mass to 15% by mass inclusive, in view of obtaining lightness and unclouded transparency. If the pigment mass concentration is smaller than 3% by mass, the multilayered coating film could fail to obtain cloudless transparency, lightness, and high-quality color tone. If the pigment mass concentration is greater than 15% by mass, quality of the coating film could deteriorate. More preferably, the pigment mass concentration ranges from 5% by mass to 10% by mass.

As needed, the metallic base paint may contain such components well known by those skilled in the art as an extender pigment, a curable catalyst, a surface modifier, an ultraviolet absorber, and an antioxidant.

The metallic base paint may be provided in a form of any given type, such as a solvent type, a water-dispersible type, or a water-soluble type.

On the metallic base coating film alone formed of the metallic base paint, the light reflectance measured at the light receiving angle of 15° ranges from 20% to 50% inclusive when the wavelength ranges from 450 nm to 700 nm inclusive, and the light reflectance measured at the light receiving angle of 45° is 2.5% or below when the wavelength ranges from 450 nm to 700 nm inclusive. Such a characteristic of the light reflectance is necessary especially when the paint color is greyish. If the characteristic of the light reflectance is out of this range, it is disadvantageous for producing gray. Preferably, the light reflectance at the light receiving angle of 15° ranges from 25% to 45% inclusive when the wavelength ranges from 450 nm to 700 nm inclusive. When the wavelength ranges from 450 nm to 700 nm inclusive, the light reflectance at the light receiving angle of 45° is preferably 0.5% or above, and still more preferably, the light reflectance ranges from 1% to 1.5% inclusive.

A light reflectance of the metallic base coating film alone can be measured as described below. Metallic base paint is prepared and, for example, sprayed on a polypropylene plate to have a predetermined thickness of coating film when dried. The coating film is then heated to cure. After that, the coating film is removed from the polypropylene plate to form a single metallic base coating film. The “single metallic base coating film” means a coating film obtained when the metallic base coating film alone is removed from a base material. The light reflectance can be measured with the same technique as that used for the single colored base coating film.

As described above, especially when the paint color is grayish, the light reflectance at the light receiving angle of 15° necessarily ranges from 20% to 50% inclusive when the wavelength of light ranges from 450 nm to 700 nm inclusive. When the wavelength of the light ranges from 450 nm to 700 nm inclusive, the light reflectance at the light receiving angle of 45° needs to be 2.5% or below.

If the light reflectance at the light receiving angle of 15° is below 20%, the lightness of the multilayered coating film to be obtained decreases. If the light reflectance at the light receiving angle of 15° is above 50%, the transparency of the multilayered coating film to be obtained decreases. Moreover, if the light reflectance at the light receiving angle of 45° is above 2.5%, it is disadvantageous for reducing color unevenness. This light reflectance of above 2.5% means that the orientation of the luster material such as aluminum flakes is significantly disordered. As a result, the multilayered coating film tends to develop color unevenness.

Moreover, as described above, the light reflectance at the light receiving angle of 45° is preferably equal to or above 0.5%. If the light reflectance falls below 0.5%, appearance of the multilayered coating film at a specular reflection angle deteriorates. Specifically, this light reflectance of below 0.5% means that the surface of the coating film becomes close to a mirror surface and a plated surface, and the intensity of the specular reflected light is high. In this case, the coating film surface becomes only partially bright (glows in white) on a spot which specular-reflects the light. If an angle of view slightly shifts even near the specular reflection angle, the brightness suddenly decreases. In other words, the highlighted portion is seen only in a limited area (i.e., it does not seem that a relatively wide area on the surface is shining), which deteriorates the appearance.

The light reflectance of the metallic base coating film alone is adjusted through adjustment of types of color pigments and luster materials contained in the metallic base paint, a mass concentration of the color pigments and the luster materials, and furthermore, a thickness of the film in a paint job. Specifically, when a paint color is grayish, paint contains a color pigment of carbon black, and has a pigment mass concentration ranging from 10% by mass to 20% by mass inclusive, and the paint is applied to have a dry film thickness ranging from 1 μm to 5 μm inclusive. Consequently, the obtained multilayered coating film can reduce the risk of color unevenness, produce even color tone, keep the multilayered coating film unclouded and transparent, and provide the multilayered coating film with depth in color.

The metallic base paint may be diluted with an organic solvent and/or water so that a solid content concentration and a viscosity of the metallic base paint can be appropriately adjusted.

In order to reduce bleeding and inverting between the metallic base coating film obtained in the step (2) and the transparent clear coating film obtained in the step (3) to be described later, a temporal interval may be provided between the step (2) and the subsequent step (3) in a similar manner as the step (1) proceeds to the step (2). Moreover, during the interval, the article to be coated provided with the colored base coating film may be heated. The interval and the heating may be provided in a similar manner as the step (1) proceeds to the step (2).

<Transparent Clear Coating Film, Step (3)>

The transparent clear coating film can prevent loss of color in the colored base coating film and the metallic base coating film, and, furthermore, provide a multilayered coating film to be obtained with high transparency and depth in color.

The clear paint forming the transparent clear coating film is preferably curable paint, in view of properties of a coating film to be obtained. The clear paint contains a coating-film forming component. Examples of the coating-film forming component include the combination of the resins and the curing agents described in the above statements of the colored base paint. In view of acid resistivity, the coating-film forming component preferably includes a combination of acrylic resin and/or polyester resin having active hydrogen-containing functional group such as a hydroxyl group and a curing agent of polyisocyanate resin blocked as needed, and a combination of carboxylic acid group containing acrylic resin and/or polyester resin and epoxy group containing acrylic resin.

The clear paint can contain such various additives well known by those skilled in the art as a surface modifier, a viscosity control agent, an ultraviolet absorber, and a light stabilizer.

Preferably, the clear paint does not contain a color pigment and a luster material in view of anti color-loss, weather resistance, and depth in color of a coating film to be obtained.

The clear paint may be provided in a form of any given type, such as a solvent type, a water-dispersible type, a water-soluble type, or a powder type.

If, in the step (3), the clear paint to be applied is one of the solvent type, the water-dispersible type, or the water-soluble type, the clear paint may be diluted with an organic solvent and/or water so that a solid content concentration and a viscosity of the clear paint can be appropriately adjusted.

A technique to apply the clear paint in step (3) is not limited to a particular technique. The technique may be appropriately selected in accordance with the type and form of the clear paint. Specifically, for example, the clear paint may be applied by (i) air spray painting, airless spray painting, and electrostatic spray painting if the paint is the solvent type, the water-dispersible type, or the water-soluble type, and (ii) powder painting if the paint is a powder type. The film thickness usually ranges, but not limited in particular to, 30 μm to 50 μm inclusive when dried.

<Step (4)>

In the step (4), the colored base coating film obtained in step (1), the metallic base coating film obtained in step (2), and the transparent clear coating film obtained in step (3) are heated to cure to form the multilayered coating film.

A condition for heating to cure is not limited to a particular condition. For example, the coating films are dried or cured at a predetermined temperature for a predetermined time period, such that the surface of the article to be coated is provided with a multilayered coating film having high-quality color tone. The predetermined temperature and the predetermined time period may be set appropriately, in accordance with the type of the clear paint and others.

The obtained multilayered coating film having high-quality color tone excels in transparency, color depth, and color tone with high chroma. Without strict reduction in film thickness variation in a paint job, the multilayered coating film can reduce occurrence of, for example, color unevenness, and obtain even color tone. For example, a dry film thickness of the multilayered coating film having high-quality color tone ranges from, but not limited in particular to, 30 μm to 100 μm inclusive.

### EXAMPLES

The present invention will be described in further detail using Examples, which are however not intended to limit the scope of the present invention.

[Preparing Colored Base Paint 1]

Sixty five point six parts by mass of a solid content of acrylic resin (manufactured by Nippon Paint Co., Ltd.) was put in a stainless steel container. To this container, 11.0 parts by mass of EMPEROR 2000 (a trade name of carbon black manufactured by Cabot Corporation) was added and dispersed so that a particle size of EMPEROR 2000 became 0.4 μm or smaller. Then, 15.5 parts by mass of a solid content of YUBAN 128 (a trade name of butylated melamine resin manufactured by Mitsui Chemicals Inc.) was added. The mixture was stirred with a desk-top stirring machine to prepare colored base paint 1 shown in Table 1. This colored base paint 1 was adjusted to have a paint viscosity.

[Measuring Light Reflectance of Single Colored Base Coating Film]

A dull finished steel plate treated with zinc phosphate was electrodeposition-coated with POWERNICS 110 (cationic electrodeposition paint composition manufactured by Nippon Paint Co., Ltd.) so that POWERNICS 110 had a dry film thickness of 20 μm. The paint was heated at 160° C. for 30 minutes to cure such that an electrodeposition coating film was obtained. On this article to be coated, the colored base paint 1 was sprayed so that a coating film of the colored base paint 1 has a dry thickness of 12 μm. The colored base paint 1 was heated at 140° C. in a hot-air drying oven for 20 minutes to cure, such that a single colored base coating film was obtained. Using the type U-3310 spectrophotometer manufactured by Hitachi, a light reflectance of this single colored base coating film at light receiving angles of 15° and 45° was measured in a wavelength scan mode with a wavelength ranging from 300 nm to 780 nm inclusive, a scanning speed of 300 nm/min, and a sampling interval of 0.5 nm.

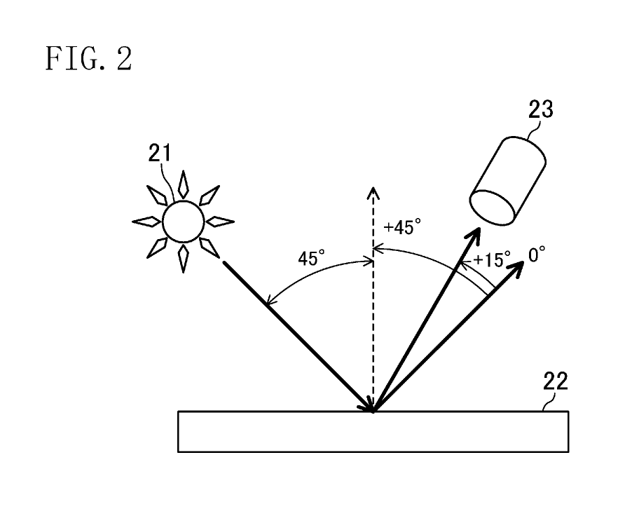

FIG. 2 is a diagram for explaining how to measure a light reflectance. A light source 21 emitted light to a coating film surface 22 at an angle of 45° with respect to a normal line of the coating film surface 22. A specular reflection angle of the light was 0°. A sensor (the spectrophotometer) 23 was provided to receive the light at an angle of 15° from the specular reflection angle toward the light source 21 in order to measure a light reflectance at a light receiving angle of 15°. In a similar manner, the sensor 23 was provided to receive the light at an angle of 45° from the specular reflection angle toward the light source 21 in order to measure a light reflectance at a light receiving angle of 45°.

[Preparing Metallic Base Paint 1]

Thirty three point three parts by mass of a solid content of acrylic resin (manufactured by Nippon Paint Co., Ltd.) was put in a stainless steel container. To this container, 16.2 parts by mass of EMPEROR 2000 (a trade name of carbon black manufactured by Cabot Corporation) was added and dispersed so that a particle size of EMPEROR 2000 became 5 μm or smaller. Then, 13.5 parts by mass of a solid content of YUBAN 128 (a trade name of butylated melamine resin having a solid content of 60% and manufactured by Mitsui Chemicals Inc.), and 8.0 parts by mass of a solid content of Aluminum Paste 7640NS (a trade name of an aluminum pigment manufactured by Toyo Aluminum K.K.) were added. The mixture was stirred with a desk-top stirring machine to prepare metallic base paint 1 shown in Table 1. This colored base paint 1 was adjusted to have a paint viscosity.

[Measuring Light Reflectance of Single Metallic Base Coating Film]

The metallic base paint 1 was sprayed on a polypropylene plate to form a coating film having a thickness of 3 μm when dried. The metallic base paint 1 was then heated at 140 □ in a hot-air drying oven for 20 minutes to cure and form the coating film. After that, the coating film was removed from the polypropylene plate to obtain a metallic base coating film alone. Using the type U-3310 spectrophotometer manufactured by Hitachi, a light reflectance of this metallic base coating film alone at light receiving angles of 15° and 45° was measured in a wavelength scan mode with a wavelength ranging from 300 nm to 780 nm, a scanning speed of 300 nm/min, and a sampling interval of 0.5 nm.

[Measurement Results of Light Reflectance]

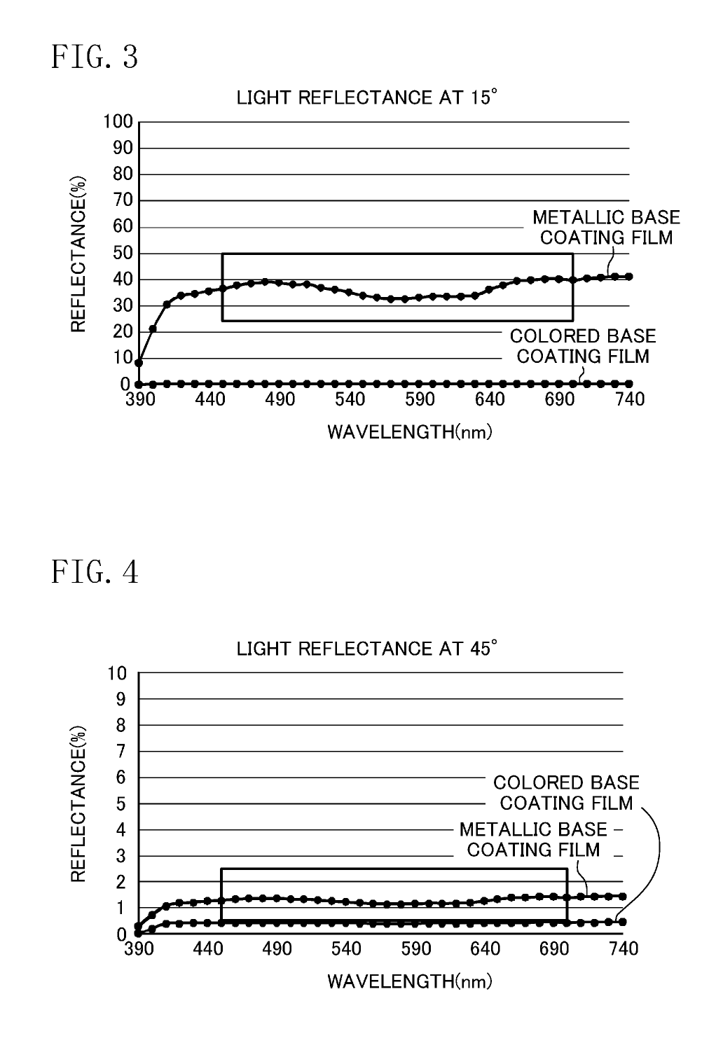

FIG. 3 illustrates a light reflectance of the single colored base coating film according to the colored base paint 1 and a light reflectance of the metallic base coating film alone according to the metallic base paint 1 at a light receiving angle of 15°. FIG. 4 illustrates a light reflectance of the coating films at a light receiving angle of 45°.

FIGS. 3 and 4 show that, in the case of the colored base paint 1, the light reflectance at the light receiving angles of 15° and 45° is 2% or below (an average light reflectance of 0.4%) when the wavelength ranges from 450 nm to 700 nm inclusive. In the case of the metallic base paint 1, the light reflectance at the light receiving angle of 15° ranges from 30% to 40% inclusive (an average light reflectance of 36.3%) when the wavelength ranges from 450 nm to 700 nm inclusive; that is, the light reflectance is within a range from 20% to 50% inclusive. The light reflectance at the light receiving angle of 45° ranges from 1% to 1.5% inclusive (an average light reflectance of 1.3%) when the wavelength ranges from 450 nm to 700 nm inclusive; that is, the light reflectance is within a range from 0.5% to 2.5% inclusive.

[Preparing Colored Base Paints 2 to 4 and Measuring Light Reflectance]

In a similar manner as the colored base paint 1 was prepared, the colored base paints 2 to 4 were prepared in accordance with the components and compositions described in Table 1, and a light reflectance of a single colored base coating film for each of the colored base paints 2 to 4 was measured. Table 1 shows the results.

[Preparing Metallic Base Paints 2 to 6 and Measuring Light Reflectance]

In a similar manner as the metallic base paint 1 was prepared, the metallic base paints 2 to 6 were prepared in accordance with the components and compositions described in Table 1, and a light reflectance of a metallic base coating film alone for each of the metallic base paints 2 to 6 was measured. Table 1 shows the results.

TABLE 1

| | | Colored Base | | | | Metallic Base | | | | | |
|---|---|---|---|---|---|---|---|---|---|---|---|
| Type of Paint | | 1 | 2 | 3 | 4 | 1 | 2 | 3 | 4 | 5 | 6 |
| Composition | Acrylic Resin | 65.6 | 71.3 | 61.6 | 63.3 | 33.3 | 32.7 | 36.3 | 41.3 | 35.7 | 30.5 |
| (wt %) | Carbon | 11.0 | 4.0 | 16.0 | 13.9 | 16.2 | 21.0 | 5.0 | 5.0 | 12.8 | 16.2 |
| | Melamine Resin | 15.5 | 16.8 | 14.5 | 14.9 | 13.5 | 13.3 | 14.7 | 16.7 | 14.5 | 12.3 |
| | Aluminum Paste | 0 | 0 | 0 | 0 | 8.0 | 4.0 | 15.0 | 8.0 | 8.0 | 12.0 |
| Light Reflectance | 450 nm-700 nm 15° | 0.4 | 13.2 | 4.4 | 1.5 | 36.3 | 10.9 | 21.8 | 54.5 | 43.6 | 25.4 |
| (%) | 450 nm-700 nm 45° | 0.4 | 13.2 | 4.4 | 1.5 | 1.3 | 0.4 | 12.9 | 6.5 | 2.1 | 1.0 |

[Preparing Clear Paint]

Mach Flow O-1600 clear (a trade name of acid-/epoxy-based curable clear paint manufactured by Nippon Paint Co., Ltd.) was adjusted to have a paint viscosity.

[Preparing Article to Be Coated]

A dull finished steel plate treated with zinc phosphate was electrodeposition-coated with POWERNICS 110 (a cationic electrodeposition paint composition manufactured by Nippon Paint Co., Ltd.) so that POWERNICS 110 had a dry film thickness of 20 μm. The paint was heated at 160° C. for 30 minutes to cure such that an electrodeposition coating film was formed. This electrodeposition coating film was used as the article to be coated.

[Preparation in Examples and Comparative Examples]

### Example 1

The colored base paint 1 was sprayed on the article to be coated with a meta bell (a rotary spraying type electrostatic coating machine) to have a dry film thickness of 12 μm. After a two-minute setting time, the metallic base paint 1 was sprayed with the meta bell to have a dry film thickness of 5 μm or less. After a four-minute setting time, the clear paint was sprayed with aμμ (micro-micro) bell (a rotary spraying type electrostatic coating machine) to have a dry film thickness of 35 μm. After another ten-minute setting time, the coating films were heated to cure at a temperature of 140 □ for 20 minutes. As a result, the multilayered coating film in Example 1 shown in Table 2 was obtained.

### Examples 2 to 6, and Comparative Examples 1 to 10

In a similar manner as seen in Example 1, the colored base paints 1 to 4 and the metallic base paints 1 to 6 shown in Table 1 were selectively combined together to obtain multilayered coating films shown in Examples 2 to 6 in Table 2 and Comparative Examples 1 to 10 in Table 3.

TABLE 2

| | | | Examples | | | | | |
|---|---|---|---|---|---|---|---|---|
| | | | 1 | 2 | 3 | 4 | 5 | 6 |
| Colored Base Paint | | | 1 | 1 | 1 | 4 | 4 | 4 |
| Metallic Base Paint | | | 1 | 5 | 6 | 1 | 5 | 6 |
| Light | Colored Base | 450 nm-700 nm 15° | 0.4 | 0.4 | 0.4 | 1.5 | 1.5 | 1.5 |
| Reflectance | Paint | 450 nm-700 nm 45° | 0.4 | 0.4 | 0.4 | 1.5 | 1.5 | 1.5 |
| (%) | Metallic Base | 450 nm-700 nm 15° | 36.3 | 43.6 | 25.4 | 36.3 | 43.6 | 25.4 |
| | Paint | 450 nm-700 nm 4° | 1.3 | 2.1 | 1.0 | 1.3 | 2.1 | 1.0 |

| | | | | | | | |
|---|---|---|---|---|---|---|---|
| Evaluation | Cloudlessness and Transparency | Good | Good | Average | Good | Good | Average |
| | Significant Depth in Color | Good | Average | Good | Average | Average | Average |
| | No Color Unevenness | Good | Average | Good | Good | Average | Good |

TABLE 3

| | | | Comparative Examples | | | | | | | | | |
|---|---|---|---|---|---|---|---|---|---|---|---|---|
| | | | 1 | 2 | 3 | 4 | 5 | 6 | 7 | 8 | 9 | 10 |
| Colored Base Paint | | | 2 | 3 | 2 | 2 | 2 | 3 | 3 | 3 | 1 | 1 |
| Metallic Base Paint | | | 1 | 1 | 2 | 3 | 4 | 2 | 3 | 4 | 2 | 4 |
| Light | Colored Base | 450 nm-700 nm 15° | 13.2 | 4.4 | 13.2 | 13.2 | 13.2 | 4.4 | 4.4 | 4.4 | 0.4 | 0.4 |
| Reflectance | Paint | 450 nm-700 nm 45° | 13.2 | 4.4 | 13.2 | 13.2 | 13.2 | 4.4 | 4.4 | 4.4 | 0.4 | 0.4 |
| (%) | Metallic Base | 450 nm-700 nm 15° | 36.3 | 36.3 | 10.9 | 21.8 | 54.5 | 10.9 | 21.8 | 54.5 | 10.9 | 54.5 |
| | Paint | 450 nm-700 nm 45° | 1.3 | 1.3 | 0.4 | 12.9 | 6.5 | 0.4 | 12.9 | 6.5 | 0.4 | 6.5 |

| | | | | | | | | | | | |
|---|---|---|---|---|---|---|---|---|---|---|---|
| Evaluation | Cloudlessness and Transparency | Good | Poor | Good | Good | Good | Poor | Poor | Good | Poor | Good |
| | Significant Depth in Color | Poor | Poor | Poor | Poor | Poor | Good | Poor | Poor | Good | Poor |
| | No Color Unevenness | Poor | Good | Poor | Poor | Poor | Good | Poor | Good | Good | Average |

### Evaluating Examples and Comparative Examples

Degrees of transparency and color depth, and presence or absence of color unevenness in Examples 1 to 6 and Comparative Examples 1 to 10 were visually evaluated. Tables 2 and 3 show the results. In rows “Cloudlessness and Transparency”, “Significant Depth in Color”, and “No Color Unevenness” of Tables 2 and 3, signs “Good”, “Average”, and “Poor” are denoted to show the results of the evaluation.

As shown in Table 2, Examples 1 to 6 had no problem in view of transparency, depth in color, and color unevenness of the coating films. Particularly, in Example 1, the coating film was cloudless and high in transparency, and significant in depth in color. No color unevenness was visually found. As seen in Example 1, the coating film in Example 2 exhibited high transparency. However, the coating film in Example 2 was slightly inferior in depth in color and color unevenness prevention to that in Example 1. The coating film of Example 3 was slightly inferior in transparency to that of Example 1. However, the coating film in Example 3 was good in terms of depth in color and color unevenness prevention, as seen in the coating film of Example 1. In Examples 4 to 6, the light reflectances of the single colored base coating films were higher than those in Examples 1 to 3 (0.4% in Examples 1 to 3, and 1.5% in Examples 4 to 6). Even though the coating films in Examples 4 to 6 were slightly inferior in the transparency, depth in color, and color unevenness to those of Examples 1 to 3, the former coating films were generally good in these evaluations.

In contrast, as shown in Table 3, the coating film in Comparative Example 1 exhibited a high reflectance of the colored base coating film formed of the colored base paint 2 and color unevenness. The coating film in Comparative Example 2 resulted in poor transparency and depth in color. This is because the colored base paint 3 is high in pigment concentration, causing an increase in paint viscosity. As a result, surface smoothness of the colored base coating film formed of the colored base paint 3 has decreased. In Comparative Examples 3 to 5, color unevenness was observed. This is because of an increase in lightness of the colored base coating film formed of the colored base paint 2. Moreover, in the case of Comparative Example 4, the metallic base paint contains a large amount of aluminum flakes. Disordered orientation of the aluminum flakes is interpreted as a cause of obvious color unevenness.

The transparency in Comparative Example 6 is low. This is because the colored base coating film is low in surface smoothness. Note that thanks to a decrease in reflectance by aluminum flakes, depth in color and color unevenness reduction are marked relatively good. In Comparative Example 7, the amount of carbon is small but the amount of aluminum flakes is large in the metallic base paint. Disorder in orientation of the aluminum flakes is interpreted to make color unevenness obvious and cause poor transparency and depth in color. In Comparative Example 8, the amount of aluminum flakes in the metallic base paint is appropriate; however, the decrease in carbon concentration reduces depth in color.

In Comparative Example 9, the light reflectance of the colored base coating film is 2% or below, and the light reflectance of the metallic base coating film is low at the angels of 15° and 45°. As a result, the transparency becomes poor. In Comparative Example 10, the light reflectance of the colored base coating film is 2% or below, and the light reflectance of the metallic base coating film is high at the angels of 15° and 45°. As a result, depth in color becomes poor, and the item “No Color Unevenness” is “Average.”

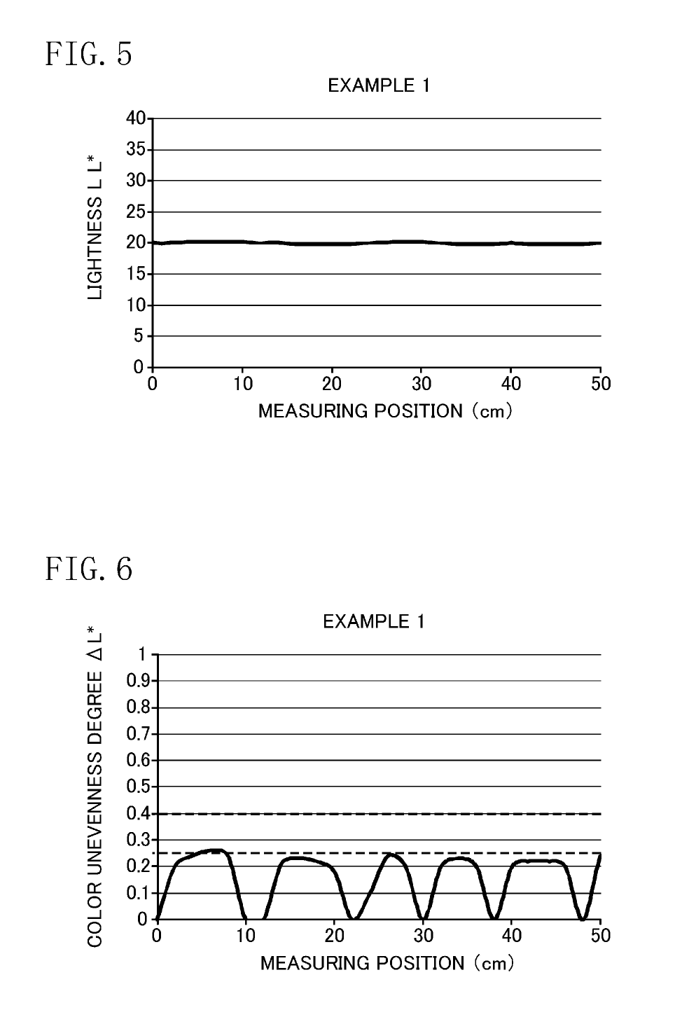

In Example 1, a spectrophotometer was used to check a degree of color unevenness. Specifically, the photometer was moved linearly in one direction on a multilayered coating film to measure a lightness L* for every 1 cm, and the absolute value of the difference between the lightness L* for each position and the average value of the lightnesses L*(L* (average)) was obtained as a color unevenness degree ΔL* (=IL*(average)−L*I). The lightness L* was measured with a spectrophotometer in accordance with JIS Z 8722 (in Example 1, a multiangle spectrophotometer MA98 manufactured by X-Rite) at a lighting angle of 45° and a light receiving angle of 45° from a specular reflection angle (receiving the light normal to the surface). FIG. 5 illustrates a result of measuring the lightness L* according to Example 1. FIG. 6 illustrates a result of measuring the color unevenness degree ΔL* according to Example 1. Color unevenness is less likely to be visible if ΔL* is 0.4 or below, and not visible if ΔL* is 0.25 or below.

FIG. 6 shows that, in Example 1, ΔL* is 0.25 or below and color unevenness is not visible.

### DESCRIPTION OF REFERENCE CHARACTERS

11 Automotive Body (Steel Plate)
12 Multilayered Coating Film
13 Electrodeposition Coating Film
14 Colored Base Coating Film
15 Metallic Base Coating Film
16 Transparent Clear Coating Film
17 Color Pigment
18 Luster Material

1. A multilayered coating film comprising:
a colored base coating film formed on a surface of an article to be coated, and containing a color pigment but not a luster material;
and a metallic base coating film formed on a surface of the colored base coating film, and containing a color pigment and a luster material, wherein
the color pigment of the colored base coating film and the color pigment of the metallic base coating film are a carbon-black-based pigment,
while the colored base coating film alone but not the metallic base coating film is formed on the surface of the article to be coated, a light reflectance at a light receiving angle of 15° and a light receiving angle at a light receiving angle of 45° are both measured to be 2% or below in a wavelength ranging from 450 nm to 700 nm inclusive, the light receiving angle representing an angle from a specular reflection angle toward a light source when a light of the light source is incident on a surface of the colored base coating film at an angle of 45° from normal to the surface, and
on the metallic base coating film alone, the light reflectance measured at the light receiving angle of 15° ranges from 20% to 50% inclusive when the wavelength ranges from 450 nm to 700 nm inclusive, and the light reflectance measured at the light receiving angle of 45° is 2.5% or below when the wavelength ranges from 450 nm to 700 nm inclusive.

2. (canceled)

3. (canceled)

4. The multilayered coating film of claim 1, wherein
the metallic base coating film has a thickness ranging from 1 μm to 5 μm inclusive and a pigment mass concentration ranging from 10% to 20% inclusive.

5. The multilayered coating film of claim 1, wherein
the luster material of the metallic base coating film includes aluminum flakes, and has a thickness ranging from 25 nm to 200 nm inclusive.

6. The multilayered coating film of claim 5, wherein
the aluminum flakes are oriented at an angle of 3° or less with respect to a surface of the metallic base coating film.

7. The multilayered coating film of claim 1 further comprising
a transparent clear coating film formed on the surface of the metallic base coating film.

8. A coated article including the multilayered coating film of claim 1.

9. The multilayered coating film of claim 4, wherein
the luster material of the metallic base coating film includes aluminum flakes, and has a thickness ranging from 25 nm to 200 nm inclusive.

10. The multilayered coating film of claim 9, wherein
the aluminum flakes are oriented at an angle of 3° or less with respect to a surface of the metallic base coating film.

11. The multilayered coating film of claim 4 further comprising
a transparent clear coating film formed on the surface of the metallic base coating film.

12. The multilayered coating film of claim 5 further comprising
a transparent clear coating film formed on the surface of the metallic base coating film.

13. The multilayered coating film of claim 6 further comprising
a transparent clear coating film formed on the surface of the metallic base coating film.

14. The multilayered coating film of claim 9 further comprising
a transparent clear coating film formed on the surface of the metallic base coating film.

15. The multilayered coating film of claim 10 further comprising
a transparent clear coating film formed on the surface of the metallic base coating film.
